(19) United States
(12) Patent Application Publication
(10) Pub. No.: US 2016/0074903 A1
(43) Pub. Date: Mar. 17, 2016

(54) APPLYING OR DISPENSING METHOD FOR POWDER OR GRANULAR MATERIAL

(71) Applicant: Mtek-smart Corporation, Yokohama-shi, Kanagawa (JP)

(72) Inventor: Masafumi MATSUNAGA, Yokohama-shi, Kanagawa-ken (JP)

(21) Appl. No.: 14/785,827

(22) PCT Filed: Apr. 18, 2014
(86) PCT No.: PCT/JP2014/061030

§ 371 Date: Oct. 20, 2015

(30) Foreign Application Priority Data
Apr. 20, 2013 (JP) 2013-088952

(51) Int. Cl. B05D 1/12

(52) U.S. Cl. CPC B05D 1/12

(57) ABSTRACT

There is provided a method for stabilizing the weight of powder or granular material applied to, dispensed to, or deposited on an object per unit area smaller than or equal to square centimeter or square millimeter. Firstly a layer of powder or granular material with a uniform weight per unit area is formed on a substrate, and then application, dispensing, or deposition is performed by sucking the powder or granular material on the substrate and ejecting it to the object.

### TECHNICAL FIELD

The preset invention relates to a method for applying or dispensing a powder or granular material to an object.

Powder or granular materials used with the method of the present invention may include inorganic materials, organic materials, inorganic compounds, organic compounds, in particular ceramics, and mixtures of them, and no mater what it is any shape, materials, and no matter how large or small in size. In the method according to the present invention, a powder or granular material may be applied or dispensed to a substrate as a dry powder or granular material. Alternatively, a powder or granular material may be mixed with a solvent, and the resultant powder slurry may be applied, dispensed or filled. The application means used in the method according to the present invention includes, but not limited to, a dispenser, slot nozzle, atomization application, electrostatic atomization application, continuous or pulsed spray, electrostatic spray, inkjet, screen spray, and screen printing.

In the method according to the present invention, any means for transferring and applying, or depositing a powder or granular material to an object, such as ejector method or vacuum sucking method (Aerosol deposition method) or combination thereof can be used, but these are not limited.

Substrates and objects used with the method according to the present invention are not limited in their number, shape, materials, and how large or small in size.

### BACKGROUND ART

Conventionally, application of powder or granular material is carried out by filling a hopper with the powder or granular material, fluidizing the powder or granular material by gas caused to flow out of the hopper through a porous plate provided at the bottom of the hopper (fluidization), sucking the powder or granular material by an ejector pump to eject it through a spray gun in a desired pattern. In typical powder coating, the object is electrically grounded, and the powder coating material is applied by electrostatically charging it by corona discharge or friction charging member.

Patent literature 1 discloses an intermittent (or pulsed) spraying of powder or granular material developed by the inventor of the present invention, which is intended to stabilize the coating amount.

Patent literature 2 discloses a method for applying powder or granular material to an object by filling a screen such as a rotary screen with the powder or granular material and releasing the powder or granular material from the side of the screen opposite to the filling side by vibration or by using compressed air. This method was also developed by the inventor of the present invention.

Non-patent Literature 1 discloses a method for supplying powder or granular material by a positive displacement micro feeder.

Non-patent Literature 2 discloses an aerosol deposition system, which has been attracting attention as a new alternative system in various fields in which dry coating is needed, because it can deposit ceramics or the like in the form of powder or granular material without using expensive, complex, and bulky equipment.

In the method disclosed in Patent Literature 1, powder or granular material is sucked with a high ejector pressure in order to achieve stable suction of the powder or granular material, and a desired amount of powder or granular material can be applied by operating the ejector in an intermittent or pulsed manner. Thus, high quality coating can be achieved in typical fields of coating because of the stability in the amount of coating.

Moreover, the ejector air is ejected also in a pulsed manner, and the air flow rate of the total air-powder mixture can be kept small, enabling extremely high application efficiency.

However, if this method is applied to coating in the field of semiconductor such as LED, which requires the accuracy of the micron order, the method cannot achieve a satisfactory result in precise coating with powder or granular material having a wide-based grain size distribution like that shown in FIG. 9, because its employs fluidization.

In the method disclosed in Patent Literature 2, the powder or granular material is supplied by positive displacement. Therefore, it is true that the method disclosed in Patent Literature 2 is advantageous in stability of supply over the method disclosed in Patent Literature 1, but it is difficult for the method disclosed in Patent Literature 2 to perform fine filling and application with a constant bulk density, and it is difficult for it to control powder or granular material having a grain size distribution shown in FIG. 9 on the order of 0.1 milligram per square centimeter or on the order of 0.001 milligram per square millimeter.

The method disclosed in Non-patent Literature 1 can also achieve macroscopically stable supply of powder or granular material such as powder coating by positive displacement. However, filling and application with powder or granular material having an average diameter of approximately 8 micrometers with a wide-based grain size distribution like that shown in FIG. 9 or a biased particle size distribution at 0.06 mg per square millimeter±3% is not suitable for microscopic filling and application using it, as in the case of the method disclosed in the aforementioned patent literature.

Aerosol deposition disclosed in Non-patent Literature 2 can form a deposited film on an object under a vacuum condition by setting the coated object in a chamber kept at a degree of vacuum of e.g. 0.4 to 2 Torr, fluidizing powder or granular material by gas, and transferring micro particles of ceramics or the like having diameters of 0.08 to 2 micrometers by the kinetic energy of differential pressure higher than 50 kPa to cause them to impinge on the object at a speed higher than 150 m/sec. However, since it employs fluidization, there still remains the problem of film thickness distribution in the deposited film per microscopic unit area, because even on the aforementioned micron order, the aforementioned smaller size particles and larger size particles show different flow behaviors, even if a pulverizer or classifier is used.

### PRIOR ART LITERATURE

### Patent Literature

Patent Literature 1: Japanese Patent Application Laid-open Publication No. S62-011574

Patent Literature 2: Japanese Patent Application Laid-open Publication No. H5-76819

### Non Patent Literature

Non-patent Literature 1: Website of Aishin Nano Technologies CO. LTD.

Non-patent Literature 2: Website of National Institute of Advanced Industrial Science And Technology

### SUMMARY OF INVENTION

### Technical Problem

The above-described problem can be solved to some extent by making the grain size distribution of the supplied material sharp and shaping the particles of the powder or granular material into shapes that facilitate the transfer. However, this leads to a large increase in the material cost, and it is almost impossible to shape the particles of the powder or granular material into the same shape.

For the above reason, it is not possible for the methods disclosed in the aforementioned patent literatures and non-patent literatures to stabilize the coating weight per unit area, in particular the coating weight in an area smaller than one square millimeter.

### Means for Solving Problem

The present invention has been made to solve the above-described problem, and an object of the present invention is to provide a method for applying or distributing powder or granular material at equalized coating weight per unit area.

According to the present invention, there is provided a method for applying or dispensing powder or granular material to an object comprising: a first step of uniformizing the weight per unit area of powder or granular material on a substrate; a second step of providing a suction port for the powder or granular material on said substrate and an ejection port for the powder or granular material that is in communication with said suction port; a third step of setting the object at a location downstream of said ejection port; and a fourth step of transferring said powder or granular material by a differential pressure between said suction port and the ejection port and ejecting said powder or granular material from said ejection port to apply or dispense the powder or granular material to the object.

There is also provided a method for applying or dispensing powder or granular material to an object having the same features as the above described method according to the present invention and characterized in that said substrate is a substrate provided with a recess or through hole, or a screen, and when filling or coating said recess, through hole, or screen with the powder or granular material, the bulk density of said powder or granular material is kept uniform.

There is also provided a method for applying or dispensing powder or granular material to an object having the same features as the above described method according to the present invention and characterized in that to uniformize the weight of the powder or granular material on said substrate per unit area, at least a solvent is added to said powder or granular material to form a mixed slurry, and the coating or filling is performed with the slurry.

There is also provided a method for applying or dispensing powder or granular material to an object having the same features as the above described method according to the present invention and characterized in that the powder or granular material on said substrate is applied in advance in one to fifty layers by an application apparatus.

There is also provided a method for applying or dispensing powder or granular material to an object having the same features as the above described method according to the present invention and characterized in that said application apparatus is a spray apparatus or a pulsed spray apparatus, and said substrate and said spray apparatus or pulsed spray apparatus is moved relative to each other.

There is also provided a method for applying or dispensing powder or granular material to an object having the same features as the above described method according to the present invention and characterized in that said substrate and said suction port are and said ejection port and the object are moved relative to each other, and said powder or granular material is applied to the object in one to thirty layers.

There is also provided a method for applying or dispensing powder or granular material to an object having the same features as the above described method according to the present invention and characterized in that suction of the powder or granular material on said substrate is performed in a state in which the substrate and the suction port are in contact with or in proximity to each other.

There is also provided a method for applying or dispensing powder or granular material to an object having the same features as the above described method according to the present invention and characterized in that at least said ejection port and the object are placed under vacuum.

There is also provided a method for applying or dispensing powder or granular material to an object having the same features as the above described method according to the present invention and characterized in that the suction of said powder or granular material is performed spot by spot while moving said substrate or said suction port directed to the said substrate to and fro, and the powder or granular material is applied to the object spot by spot.

There is also provided a method for applying or dispensing powder or granular material to an object having the same features as the above described method according to the present invention and characterized in that at least said object is placed under vacuum, and said differential pressure is equal to or higher than 50 kPa, so that the powder or granular material is caused to impinge on the object to deposit a film thereon concurrently with the application.

In the method for applying or dispensing powder or granular material to an object according to the present invention, it is preferred that the grain diameter of the powder or granular material be between 0.08 and 60 micrometers.

There is also provided a method for applying or dispensing powder or granular material to an object having the same features as the above described method according to the present invention and characterized in that a layer of a binder or a mixture of a binder and the powder or granular material is formed beforehand on said object.

There is also provided a method for applying or dispensing powder or granular material to an object having the same features as the above described method according to the present invention and characterized in that said powder or granular material is phosphor, and said object is an LED.

With the method for applying or dispensing powder or granular material to an object according to the present invention, it is possible to perform filling while uniformizing the bulk density of powder or granular material on a substrate and to apply phosphor having a specific gravity of approximately 4 to a substrate at a small coating weight such as 0.06 mg to 0.6 mg per square centimeter in one layer. When coating at a small weight per layer is desired, it is possible to form an amazingly thin layer of powder or granular material as thin as 0.6 mg per square centimeter in ten layers, by preparing a slurry by diluting the powder or granular material by solvent to a concentration equal to or lower than 50 wt %, preferably 5 wt % and applying the slurry to the substrate by intermittent (or pulsed) spraying.

If the spraying is performed in a closed small booth while moving the substrate and the spray apparatus relative to each other, the solvent can be collected. The technique disclosed in WO2013/03953A1, which was filed by the applicant of the present patent application and has been laid open, may be applied to this method. Specifically, agitators may be set in two syringes used in the method for improving prevention of settling and caused to rotate or move up and down, and a slurry composed only of a powder or granular material having a specific gravity equal to or higher than 3 and a solvent having a specific gravity equal to or lower than 1 and having such an ultra-low viscosity that the powder or granular material settles instantly may be moved into the left and right syringes. Simultaneously, the spray apparatus and the substrate may be moved stepwise at a certain pitch with an offset. Thus, the powder or granular material can be applied in a desired number of thin layers in the range of 2 to 50 layers. The multiplicity of the layers enables the formation of a thin layer with a uniformized grain size distribution while keeping the variation in the coating weight per unit area within±5%, preferably±1.5% even with the powder or granular material having the grain size distribution shown in FIG. 9. Consequently, the coating weight on the coated object can also be stabilized.

Therefore, increasing the number of application to the object through the ejection port or the number of coating layers by employing, for example, a method disclosed in WO/2011/083841, which was filed by the applicant of the present patent application and has been laid open, leads to a further improvement in the stability of the coating weight.

The substrate may be a disk, a cylinder, a flat plate, a block, a film, or a coil or may have any size and shape and may be made of any material. To reduce contamination of the substrate, it is preferred that the material of the substrate be the material same as the powder or granular material having a high hardness or a ceramic material which is free from abrasion or break-off or which has only a negligible degree of abrasion or break-off. In the case where a metal plate is used as the substrate, it is preferred that the surface of the metal plate be mirror-finished, or coating with a ceramic material or plating may be applied to it.

The substrate may be a disk or block provided with recesses or a screen, which may be filled with powder or granular material or slurry. When filling with dry powder or granular material is performed, it is preferred that the substrate or the powder or granular material be vibrated by, for example, supersonic waves to uniformize the bulk density. The powder or granular material, whether dry or wet like slurry, may be applied in advance to a film, a coil or a sheet in as many layers as possible to uniformize the weight. In the case where a powder or granular material having a wide-based grain size distribution is used, an electrical conductive material is used as the substrate, or conductive treatment may be applied to the substrate, and application may be performed utilizing electrostatic device to form multiple layers with different phases. Then, the weight of the powder or granular material per unit area can further be stabilized.

As described above, by the method according to the present invention, application, distribution, or deposition of powder or granular material on an object can be uniformized in a microscopic sense. In the case where the method according to the present invention is applied to aerosol deposition, high quality deposition of ceramic materials or the like can be performed at low cost. In the case where the method according to the present invention is applied to application of phosphor to LEDs, complicated and high cost conventional methods can be eliminated, and the cost of the phosphor can be reduced by ten times or more. This is effective not only in reducing cost but also in saving in rare materials.

### BRIEF DESCRIPTION OF DRAWINGS

FIG. 1 is a schematic cross sectional view illustrating a first embodiment of the present invention.

FIG. 2 is a schematic cross sectional view of a substrate according the first embodiment of the present invention.

FIG. 3 is a schematic cross sectional view of another substrate according to the first embodiment of the present invention.

FIG. 4 is a schematic cross sectional view illustrating coating of a substrate according to a second embodiment of the present invention.

FIGS. 5A and 5B are schematic diagrams illustrating application of powder or granular material to a substrate using a mask according to a third embodiment of the present invention.

FIG. 6 is a schematic cross sectional view illustrating application of patterned powder or granular material shown in FIGS. 5A and 5B according to a fourth embodiment of the present invention.

FIG. 7 is a schematic cross sectional view illustrating a fifth embodiment of the present invention.

FIG. 8 is a schematic cross sectional view illustrating a sixth embodiment of the present invention.

FIG. 9 shows an exemplary grain size distribution of powder or granular material.

### DESCRIPTION OF EMBODIMENTS

In the following preferred embodiments of the present invention will be described with reference to the drawings. The following embodiments are given only for the illustrative purpose to facilitate the understanding of the invention, and not intended to exclude feasible additions, replacements, modifications made thereto by persons skilled in the art without departing from the technical scope of the present invention.

The drawings schematically show preferred embodiments of the present invention.

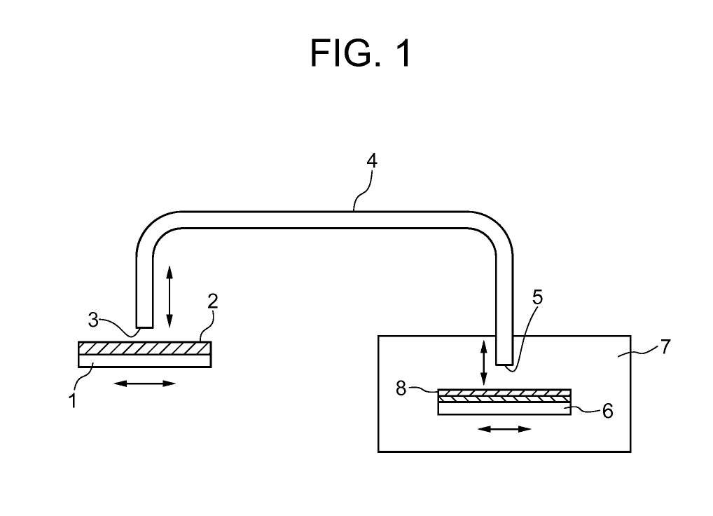

In FIG. 1, a substrate 1 is coated with powder or granular material 2 at a controlled uniform weight per unit area. An allowable degree of uniformity in the weight is within the range of±5% of the designated value of the weight per square centimeter, and is preferably within the range of±1.5%. For example, in the case where the designated weight per square centimeter is 0.6 mg, the allowable variation is±0.03 mg or±0.009 mg. The powder or granular material can be sucked easily by bring the suction port 3 to the proximity of or in contact with the surface of the powder or granular material. The powder or granular material is transferred from the suction port 3 to an ejection port 5 located in a coating chamber 7 through a communication channel 4 of the coating apparatus and applied to an object 6 to form a coating layer 8. The ejection port 5 may be a nozzle having a circular, rectangular, or slit-like shape. The ejection port 5 may have any shape and size, but it is preferred that the ejection port 5 has a selected shape and size suitable for the object. The means for uniformizing the material weight per unit area on the substrate performs coating in as many layers as possible, e.g. in 100 layers, thereby uniformizing the grain size distribution of the powder or granular material. Thus, the weight per unit area thereof can be uniformized. Alternatively, a plurality of substrates having single or multiple layers of applied material may be prepared for averaging. When the object is coated with the powder or granular material ejected from the ejection port 5, coating may be performed not in single layer but in multiple layers with the weight per unit area being made as small as possible, thereby increasing the coating weight of the powder or granular material on the coated object. When multilayer coating of the substrate or the object is performed, it is preferred that the application means and the substrate, and the suction port and the substrate, or the ejection port and the substrate be moved relative to each other.

The application method and apparatus may employ ejection, but vacuum suction is preferable. There is a differential pressure between the suction port for the powder or granular material and the ejection port for the powder or granular material of the coating apparatus, which is created by a negative pressure (vacuum) established in the coating chamber 7 in which the object is set. Thus, the powder or granular material can be sucked through the suction port and applied to the object. The differential pressure may be set to be equal to or higher than 50 kPa thereby making the ejection speed of the powder or granular material equal to or higher than 150 m/sec to cause it to impinge on the object, whereby fine powder or granular material with grain diameters approximately between 0.08 and 2 micrometers can also be deposited. Difference in pressure 50 kPa or higher shall mean a vacuum degree being higher.

The atmosphere around the substrate and the suction port may be in a vacuum condition, so long as the differential pressure equal to or higher than 50 kPa can be maintained.

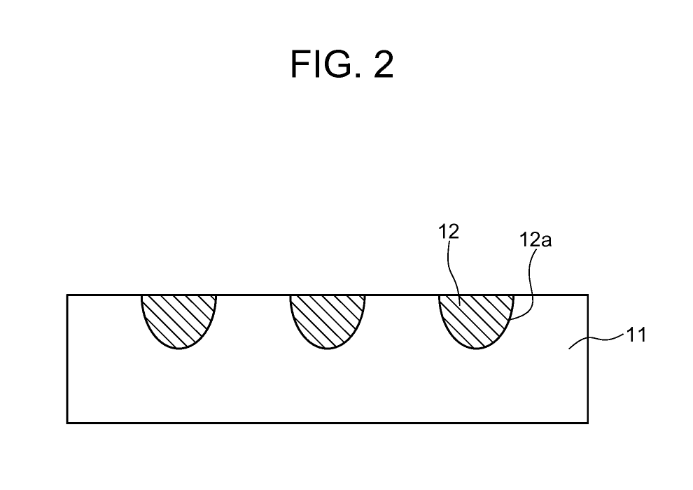

Referring to FIG. 2, a recessed portion 12a is formed in the substrate 11. The recesses 12a is filled with powder or granular material 12, and the powder or granular material overflowing from the recesses 12a is removed, if necessary. When filling them, it is preferred that the substrate 11 be vibrated by ultrasonic or the like to uniformize the bulk density of the powder or granular material. The powder or granular material may be caused to pass through a mesh to which ultrasonic vibration is applied, whereby agglomerated powder or granular material can be reduced to primary particle. The volume of the recesses 12a is made as small as possible, and the powder or granular material in the plurality of recesses 12a is sucked multiple times and applied to the object in a spot pattern or continuously from the ejection port multiple times.

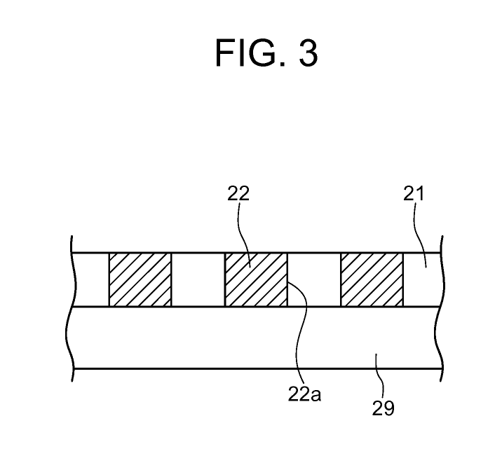

Referring to FIG. 3, through holes 22a of a substrate 21 or openings of a screen are filled with powder or granular material 22. It is preferred that a leak prevention plate or a mesh 29 having a permeability smaller than the powder or granular material be placed below the substrate 21 and vibrated to uniformize the bulk specific gravity, thereby uniformizing the weight of the powder or granular material per unit area or unit volume.

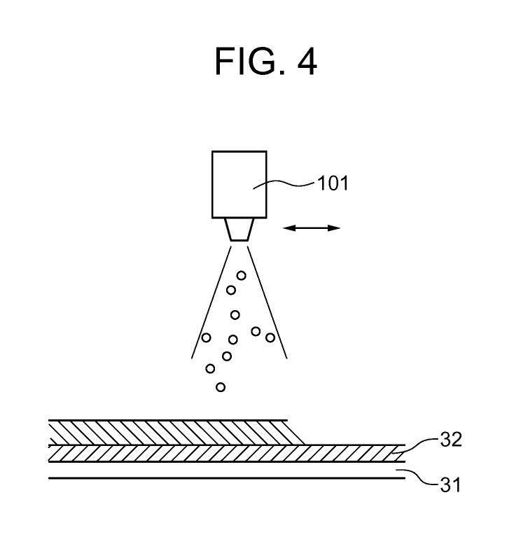

Referring to FIG. 4, multilayer coating with powder or granular material is performed while a substrate 31 and an applicator 101 are moved relative to each other. The coating apparatus may be a powder or granular material spray apparatus, which can form a uniform layer of the powder or granular material by electrostatic charging the powder or granular material or the substrate. The powder or granular material may be mixed with solvent, and the resultant slurry may be applied to the substrate by die coating or spraying to form multilayer coating. In the case of spraying, the surface of the substrate may be grounded and the spray particles may be charged by electrostatic. Attaching the material to the substrate in the form of slurry is more preferable than in the form of powder in achieving higher initial adhesiveness and coating with uniform bulk density. It is ideal that spray coating of the substrate with a material, whether a powder or granular material or slurry, be performed in a pulsed manner with intermittent supply of gas, because the flow rate can be reduced, the coating can be made thin, and the coating efficiency can be enhanced. In the case of slurry, the substrate may be heated when coating is performed in an intermittent or pulsed manner to form multiple thin layers. Then, the solvent can be vaporized instantly.

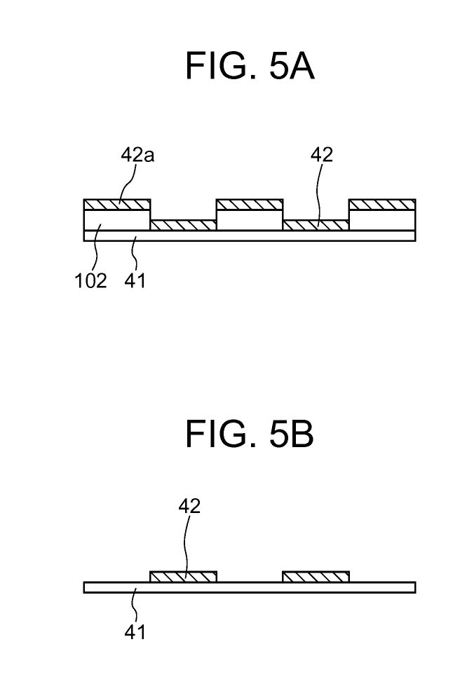

Referring to FIG. 5A, a mask 102 is placed on a substrate 41, and coating is performed by the method according to the present invention illustrated in FIG. 1 or 4. With this arrangement, a powder or granular material pattern 42 having a desired shape and thickness can be formed as shown in FIG. 5B. This method advantageously enables spot coating with the powder or granular material at desired positions on the object. The powder or granular material 42a on the mask can be collected for reuse. The powder or granular material may be applied in the form of powder, or alternatively it may be applied in the form of slurry to form multilayer coating.

In all the illustrated embodiments, the application or distribution of powder or granular material to the substrate by the applicator may be performed while moving the substrate and the applicator relative to each other according to, for example, the method disclosed in WO/2011/083841.

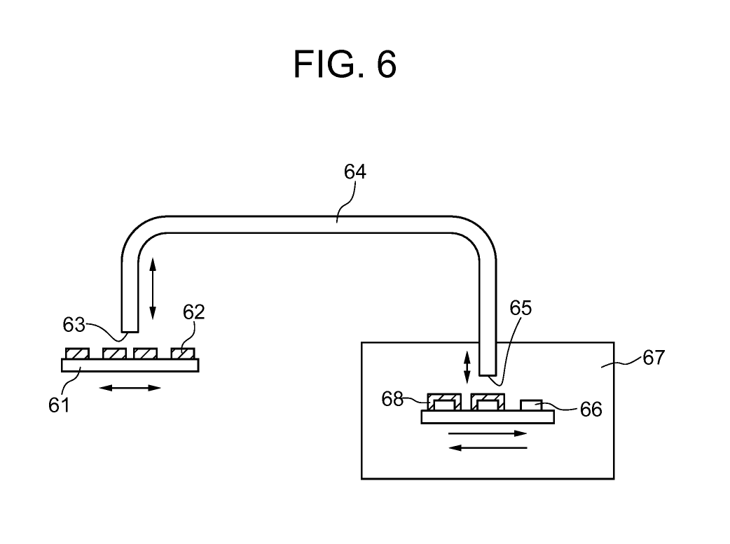

As shown in FIG. 6, a patterned powder or granular material 62 formed on a substrate 61 by the method illustrated in FIG. 5 can be transferred through a communication channel 64 to a coating chamber 67 in which a negative pressure (or vacuum) is established, and a desired powder or granular material such as a phosphor can be applied to an object 66, which may be a finished LED chip or unfinished LED chip, in multiple thin layers, or coating with the powder or granular material may be formed. Reference numeral 68 designates a coating layer.

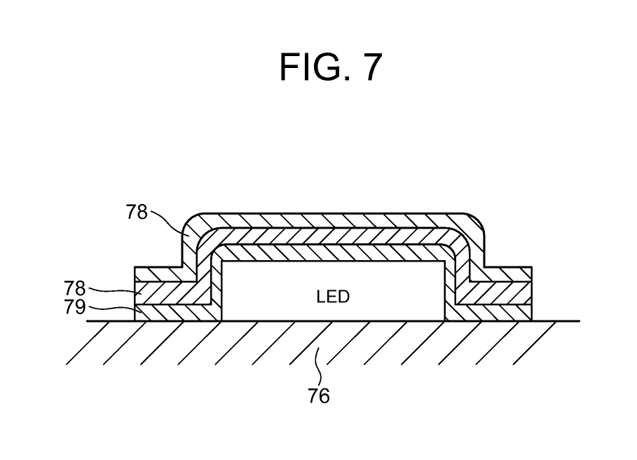

Referring to FIG. 7, binder 79 such as silicone resin or binder containing a little quantity of powder or granular material such as phosphor is applied beforehand to a base plate 76 of an object such as an LED chip, and then powder or granular material 78 such as phosphor is applied and attached to the binder. If the powder or granular material is given high speed energy, the powder or granular material can penetrate into the binder. Different kinds of powder or granular materials or the same kind of powder or granular material may be applied in multiple layers, or different kinds of powder or granular materials or the same powder or granular material and the binder may be applied in multiple layers. In order to form a thin layer or film of the binder, it is preferred that the binder be diluted by solvent to reduce the viscosity and spray coating with impact given to particles be performed in a pulsed manner, because by this method, the side surface of the LED can be coated completely.

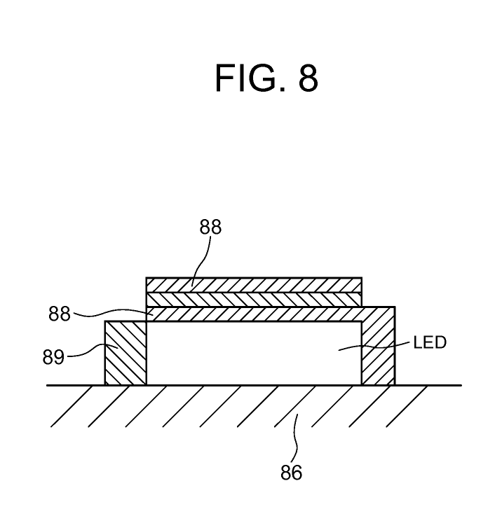

Referring to FIG. 8, a wall (not shown) is formed by a dam or masking around a chip such as an LED chip on a substrate 86, and a space formed thereby is filled with binder 89 or resin containing binder and a small quantity of powder or granular material, and powder or granular material 88 is applied thereon. The powder or granular material may be a phosphor, and the binder may be a thermoset silicone. To facilitate ease of filling, it is preferred that the filling resin such as silicone be mixed with solvent to reduce the viscosity.

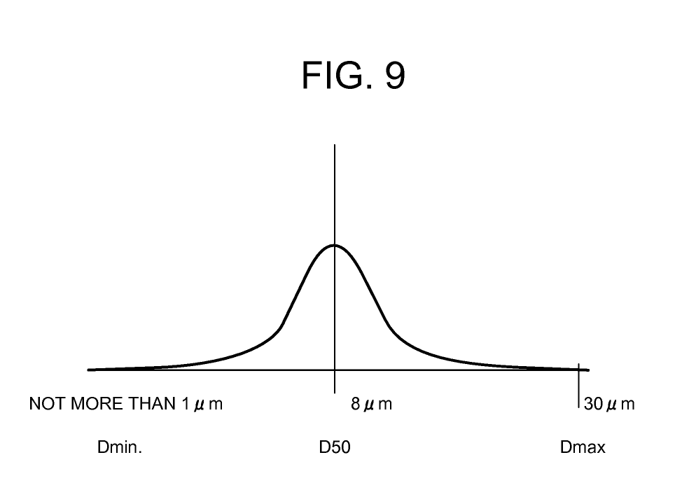

FIG. 9 shows a particle size distribution of a typical phosphor for LED.

It is not possible for the conventional techniques to apply powder or granular material having a wide-based particle size distribution microscopically uniformly. Specifically, it is very difficult at least to form a thin coating with a variation in weight per square centimeter or square millimeter of±3% or preferably±1.5% by one application. Even in the case where the powder or granular material has a sharp particle size distribution, there naturally are large particle portions and small particle portions, and particle shapes are not uniform, when seen microscopically.

In the method according to the present invention, the weight of the powder or granular material per unit volume is uniformized in a processing step prior to dispensing or depositing a film of powder or granular material to an object. For uniformization, when the powder or granular material is applied to a substrate in the prior processing step, the application is performed multiple times while moving the powder or granular material applicator and the substrate relative to each other. Specifically, coating of a first layer is performed while moving the substrate stepwise at a certain pitch and causing the application apparatus to traverse. Then, a second layer, third layer etc. are formed with different pitch phases. Alternatively, the application apparatus may be moved stepwise at a certain pitch and the substrate may be caused to traverse. Alternatively, these two ways of application may be performed alternately to achieve more uniform coating weight. The coating material may be either powder or granular material or slurry in which powder or granular material and solvent are mixed, and the method or means for application is not limited, but pulsed spraying is preferred because it can achieve high transfer efficiency. Moreover, at least a coated portion of the substrate may be electrically grounded, and the powder or granular material or the slurry may be electrostatically electrostatic charged when applying it. Then, even fine particle can be attached to the substrate, and the uniformity can further be improved. In the case where the powder or granular material is not apt to be charged negatively or positively by its nature, it is effective to add a solvent that can be easily charged.

Thus, the weight per unit area or microscopic unit area can be uniformized also from an aspect of the probability.

The present invention is not limited to applying one kind of powder or granular material or slurry to a substrate by a single applicator, but multiple kinds of powder or granular materials or slurries may be applied in multiple layers using a plurality of applicators.

In the present invention, multiple kinds of powder or granular materials or slurries may be applied to a plurality of substrates using a plurality of applicators, and the powder or granular materials on the respective substrates may be applied to an object in desired order in multiple layers. The apparatus may be provided with one suction port and one ejection port. Alternatively, the suction port and the ejection port may be provided for each kind of powder or granular material.

The present invention is not limited to applying one kind of powder or granular material or slurry to a substrate by a single applicator, but multiple kinds of powder or granular materials or slurries may be applied in multiple layers using a plurality of applicators.

In the present invention, multiple kinds of powder or granular materials or slurries may be applied to a plurality of substrates using a plurality of applicators, and the powder or granular materials on the respective substrates may be applied to an object to be coated in desired order in multiple layers. The apparatus may be provided with one suction port and one ejection port. Alternatively, the suction port and the ejection port may be provided for each kind of powder or granular material.

In the case where the object is an LED and the powder or granular material is a phosphor, it is possible to manufacture an LED by applying multiple kinds of phosphor to the LED in multiple layers. The phosphor for forming the multiple layers may be selected at least from red, green, yellow, and blue phosphor. The order of application of the phosphor is not limited. For example, in the case where the LED is one that emits blue light, the phosphor may be applied in layers in descending order of the wavelength of the phosphor. A desired combination of phosphor may be applied in multiple layers on a color-by-color basis while making the weight per unit area as small as possible.

When powder or granular material or slurry is applied to a substrate by an applicator, it is preferred to move the substrate and the applicator relative to each other, to move one of them stepwise at a desired pitch, to cause the other to traverse, and to apply the second and subsequent layers with an offset, thereby achieving more uniform coating distribution of the powder or granular material than in the case where application is performed at a smaller pitch, e.g. one tenth smaller pitch. The applicator may be moved stepwise at a certain pitch, and a cylindrical substrate or a substrate in the form of a film wrapped around a cylinder which can be rotated may be employed. The film may be moved by a roll-to-roll system.

Likewise, it is preferred to move the ejection port and the object relative to each other, to move one of them stepwise at a certain pitch, to cause the other to traverse to carryout application to a surface, and to apply the second and subsequent layers with an offset, thereby achieving more uniform coating with the powder or granular material. Alternatively, the ejection port may be moved stepwise at a certain pitch, and the object may be a cylinder or a film wrapped around a cylinder which is rotated. The film or a metal coil as the object is wound by a roll-to-roll system, and therefore the powder or granular material may be deposited.

### INDUSTRIAL APPLICABILITY

The present invention can be applied not only to coating of LEDS but also to coating in the fields of semiconductor, electronic parts, biotechnology, and pharmaceuticals where microscopic application or distribution of powder or granular material is needed. When applied to aerosol deposition process, the present invention can achieve high quantity coating at low cost. Moreover, the present invention can be applied to formation of electrodes of secondary batteries such as Lithium Battery, and formation of electrodes of fuel cells, in particular formation of platinum-supporting carbon electrodes PEFCs or DMFCs, of which the membrane is delicate to solvent and water. And formation of electrodes of SOFC, which may suffer from bowing in the sintering process if the film thickness is thick.

### REFERENCE SIGNS LIST

1, 11, 21, 31, 41, 51, 61, 71: substrate
2, 12, 22, 32, 42, 52, 62: powder or granular material on substrate
3, 63: suction port
4, 64: communication channel
5, 65: ejection port
6, 66: object
7, 67: negative pressure (vacuum) chamber
8, 68, 78, 88: coating layer
76, 86: base plate
79, 89: binder
101: spray apparatus
102: mask

1. A method for applying or dispensing powder or granular material to an object comprising: a first step of uniformizing the weight per unit area of powder or granular material on a substrate; a second step of providing a suction port for the powder or granular material on said substrate and an ejection port for the powder or granular material that is in communication with said suction port; a third step of setting the object downstream of said ejection port; and a fourth step of transferring said powder or granular material by a differential pressure between said suction port and the ejection port and ejecting said powder or granular material from said ejection port to apply or dispense the powder or granular material to the object.

2. A method for applying or dispensing powder or granular material to an object according to claim 1, characterized in that said substrate is a substrate provided with a recess or through hole, or a screen, and when filling or coating said recess, through hole, or screen with the powder or granular material, the bulk density of said powder or granular material is kept uniform.

3. A method for applying or dispensing powder or granular material to an object according to claim 1, characterized in that to uniformize the powder or granular material on said substrate, at least a solvent is added to said powder or granular material to form a mixed slurry, and the coating or filling is performed with the slurry.

4. A method for applying or dispensing powder or granular material to an object according to claim 3, characterized in that the powder or granular material on said substrate is applied in advance in one to fifty layers by an application apparatus.

5. A method for applying or dispensing powder or granular material to an object according to claim 4, characterized in that said application apparatus is a spray apparatus or a pulsed spray apparatus, and said substrate and said spray apparatus or pulsed spray apparatus are moved relative to each other.

6. A method for applying or dispensing powder or granular material to an object according to claim 5, characterized in that said substrate and said suction port are and said ejection port and the object are moved relative to each other, and said powder or granular material is applied or dispensed to the object in one to thirty layers.

7. A method for applying or dispensing powder or granular material to an object according to claim 6, characterized in that suction of the powder or granular material on said substrate is performed in a state in which the substrate and the suction port are in contact with or in proximity to each other.

8. A method for applying or dispensing powder or granular material to an object according to claim 7, characterized in that at least said ejection port and the object are placed under vacuum.

9. A method for applying or dispensing powder or granular material to an object according to claim 8, characterized in that the suction of said powder or granular material is performed spot by spot while moving said suction port directed to the object to and fro, and the powder or granular material is applied or dispensed to the object spot by spot.

10. A method for applying or dispensing powder or granular material to an object according to claim 9, characterized in that at least said object is placed under vacuum and said differential pressure is higher than 50 kPa, so that the powder or granular material is caused to impinge on the object to deposit a film thereon concurrently with the application.

11. A method for applying or dispensing powder or granular material to an object to claim 10, characterized in that the grain diameter of the powder or granular material is between 0.08 and 60 micrometers.

12. A method for applying or dispensing powder or granular material to an object according to claim 11 characterized in that a layer of a binder or a mixture of a binder and the powder or granular material is formed beforehand on said object.

13. A method for applying or dispensing powder or granular material to an object according to claim 1, characterized in that said powder or granular material is fluorescent material and said object is an LED.

14. A method for applying or dispensing powder or granular material to an object according to claim 1, characterized in that said object is an LED, said substrate and said suction port are and said ejection port and the object are moved relative to each other, and said powder or granular material is applied or dispensed to the object in one to thirty layers.

15. A method for applying or dispensing powder or granular material to an object according to claim 1, characterized in that said object is an LED, and a layer of a binder or a mixture of a binder and the powder or granular material is formed beforehand on said object.
